(19) United States
(12) Patent Application Publication
(10) Pub. No.: US 2024/0392113 A1
(43) Pub. Date: Nov. 28, 2024

(54) SULFUR-CROSSLINKABLE RUBBER COMPOSITION CONTAINING ORGANIC FILLERS AND ORGANOSILANE

(71) Applicant: Suncoal Industries GmbH, Ludwigsfelde (DE)

(72) Inventors: Alexander Stücker, Ludwigsfelde (DE); Tobias Wittmann, Ludwigsfelde (DE); Gerd Schmaucks, Ludwigsfelde (DE); Jacob Podschun, Ludwigsfelde (DE); Bernhard Schwaiger, Erftstadt (DE)

(73) Assignee: Suncoal Industries GmbH, Ludwigsfelde (DE)

(21) Appl. No.: 18/695,950

(22) PCT Filed: Sep. 27, 2022
(86) PCT No.: PCT/EP2022/076858

§ 371 Date: Mar. 27, 2024

(30) Foreign Application Priority Data
Sep. 28, 2021 (EP) 211995873

(51) Int. Cl. C08L 7/00; B60C 1/00; C08K 3/30; C08K 5/548

(52) U.S. Cl. CPC C08L 7/00; B60C 1/00; C08K 3/30; C08K 5/548; C08L 2312/00

(57) ABSTRACT

The present invention relates to a vulcanizable rubber composition, comprising a vulcanization system VS that comprises at least sulfur and/or at least one sulfur donor, a rubber component K containing at least one rubber that is cross-linkable by means of sulfur, a filler component F that contains at least one organic filler having a ¹⁴C content in a range from 0.20 to 0.45 Bq/g of carbon and a BET surface area in a range from >20 to 150 m²/g, and at least one organosilane having at least one hydrolysable group and at least one sulfur atom, to a kit of parts comprising as part (A) a rubber composition containing the above-mentioned components F and K, and as part (B) the vulcanization system VS comprising at least sulfur and/or at least one sulfur donor, wherein the above-mentioned organosilane is contained in part (A), to vulcanized rubber compositions respectively obtainable therefrom, to a use of the above-mentioned products for employment in the fabrication of tires, tire components and rubber articles, and to corresponding tires, tire components and rubber articles as such.

The present invention relates to a vulcanizable rubber composition, comprising a vulcanization system VS that comprises at least sulfur and/or at least one sulfur donor that releases sulfur under vulcanization conditions, a rubber component K containing at least one rubber cross-linkable by means of sulfur, a filler component F that contains at least one organic filler having a ¹⁴C content in a range from 0.20 to 0.45 Bq/g of carbon and a BET surface area in a range from >20 to 150 m²/g, and at least one organosilane having at least one hydrolysable group and at least one sulfur atom, to a kit of parts comprising as part (A) a rubber composition containing the above-mentioned components F and K, and as part (B) the vulcanization system VS comprising at least sulfur, wherein the above-mentioned organosilane is contained in part (A), to vulcanized rubber compositions respectively obtainable therefrom, to a use of the above-mentioned products for employment in the fabrication of tires, tire components and rubber articles, and to corresponding tires, tire components and rubber articles as such.

### STATE OF THE ART/BACKGROUND OF THE INVENTION

The employment of reinforcing fillers in rubber compositions is known in the prior art. By employing reinforcing fillers, the service characteristics of vulcanized rubber articles produced therefrom are guaranteed. For example, the employment of reinforcing fillers increases the viscosity of the rubbers and improves the fracture behavior of the vulcanizates. Here, industrial carbon blacks represent the largest part of reinforcing fillers. Industrial carbon blacks are produced by incomplete combustion of organic compounds or by thermal decomposition of hydrocarbons. Most of the industrial carbon blacks are produced by the furnace process. Because of the high amount of CO₂ during the production process, it is desirable to avoid, or to reduce to a minimum, the use of fossil energy sources for the production of fillers. In addition, industrial carbon blacks may often not be usable for certain applications for color reasons. A known alternative for the employment of industrial carbon blacks as reinforcing fillers consist of precipitated silica together with bifunctional silanes.

For the fabrication of treads for car tires, the employment of silica with BET surfaces of 120-200 m²/g together with bifunctional coupling agents, such as sulfur-functional silanes, has been known, since it was possible to extend with them, as compared to the employment of industrial carbon black, the “magic triangle” of tire performance, which consists of abrasion, rolling resistance and wet traction.

In contrast to treads, for dynamic structural parts (carcass, belt, layers, bands/strips) the wear by abrasion or the wet or dry traction do not play as important a role than in the case of tire treads. The primary goal with dynamic structural parts is to reduce the conversion of mechanical energy into heat. Heat formation is described by the loss factor tan delta (tan δ). The loss factor tan delta characterizes the viscoelastic behavior and results from the ratio of the viscous and the elastic component (loss modulus and storage modulus). The storage modulus represents the part of the mechanical energy that is stored by the system, while the loss modulus represents the mechanical energy converted into thermal energy. A low loss factor as a key FIGURE for the heat formation is thus preferred, in particular in the case of the above-mentioned dynamic structural parts.

For heat formation, the polymer used must also be taken into consideration, since it contributes to the heat formation already because of its dynamic properties. Thus, a low glass transition temperature Tg leads to a lower loss factor.

In rubber compounds for dynamic structural parts, predominantly industrial carbon blacks with low specific surface area are used with the purpose of minimizing heat formation. Heat formation, or the loss factor, may be reduced by a lower degree of filling of the reinforcing filler, larger particles of the reinforcing filler in the unit of volume under consideration, and/or a larger distance of the reinforcing particles in the unit of volume. The volume filling ratio can be reduced with a high structuration of the industrial carbon black (expressed by the so-called compressed oil absorption number (COAN)) without affecting the hardness of the structural part.

However, this independence is not valid for all the parameters. In contrast, a reduction of the loss factor—in order to achieve a lowest possible heat formation—normally affects other properties of the vulcanized rubber composition, too. Increasing the cross-linking density also leads to a lower loss factor, regardless of the reinforcing filler. A higher cross-linking density however has adverse effects on the vulcanized rubber composition, for example with regard to its tearing properties (lower elongation at failure) and ageing properties.

A substantial issue with the reinforcing filler is the fact that a reduction of the loss factor is achieved at the expense of the dynamic stiffness: at a lower value for the loss factor tan delta, typically only a low dynamic stiffness can be observed. However, such a low dynamic stiffness leads to a higher deformation of the rubber composition at the same loads, and is thus disadvantageous, in particular for the employment of rubber compositions for the production of tires or their dynamic structural parts.

Thus, there is the need to provide a rubber composition that, after its vulcanization, has both a lowest possible loss factor and a highest possible dynamic stiffness, so that the conversion of mechanical energy into heat is minimized and the vulcanized rubber composition has only lowest possible deformations under load.

### OBJECT

The object of the present invention is therefore to provide a vulcanizable rubber composition that, after its vulcanization, has a highest possible dynamic stiffness and, at the same time, a lowest possible heat formation, and that in particular allows these two parameters to be decoupled, so that the rubber composition can be adjusted more flexibly and better with regard to its performance to be achieved.

### SOLUTION

This object is achieved by the subject matters claimed in the patent claims as well as the preferred embodiments of these subject matters as described in the following specification.

A first subject matter of the present invention is a vulcanizable rubber composition comprising a rubber component K, a filler component F and a vulcanization system VS, wherein
the vulcanization system VS comprises at least sulfur and/or at least one sulfur donor,
the rubber component K contains at least one rubber that is cross-linkable by means of sulfur,
the filler component F contains at least one organic filler that has a ¹⁴C content in a range from 0.20 to 0.45 Bq/g of carbon and a BET surface area in a range from 20 to 150 m²/g, preferably from >20 to 150 m²/g, and
the vulcanizable rubber composition further comprises at least one organosilane as a part of the filler component F, wherein the at least one organosilane has at least one hydrolysable group and at least one sulfur atom, and is contained preferably in a quantity lying in a range from 0.25 to 5 phr.

Another subject matter of the present invention is a kit of parts, comprising, in spatially separated form,
as part (A), a rubber composition containing at least the above-mentioned rubber component K employed according to the invention and at least the filler component F employed according to the invention, wherein part (A) of the kit of parts however does not comprise sulfur and/or at least one sulfur donor of the vulcanization system VS employed according to the invention,
as part (B), a vulcanization system VS employed according to the invention, comprising at least sulfur and/or at least one sulfur donor,
wherein the organosilane employed according to the invention is contained in the filler component F in part (A) preferably in a quantity lying in a range from 0.25 to 5 phr.

Another subject matter of the present invention is a vulcanized rubber composition that can be obtained by vulcanization of the vulcanizable rubber composition according to the invention or by vulcanization of a vulcanizable rubber composition obtainable by combining and mixing the two parts (A) and (B) of the kit of parts according to the invention.

Another subject matter of the present invention is a use of the vulcanizable rubber composition according to the invention, of the kit of parts according to the invention or of the vulcanized rubber composition according to the invention for employment in the production of tires, preferably in the production of pneumatic tires and solid tires, and of tire components, preferably in the production of such tire components for which a lowest possible tan delta value Wert for the vulcanized rubber compositions used in their production is targeted, such as for example rubber compositions comprising natural rubber(s) and/or rubbers having a low glass transition temperature Tg, in particular in the production of tire components selected from the group of base components, i.e., components under the tread, shoulder strips (wings), cap-plies, belts, beads and/or bead reinforcements, or for employment in the production of rubber articles, such as technical rubber articles, preferably of drive belts, straps/belts, molded parts such as buffers/cushions, bearings/mounts, such as hydromounts, conveyor belts, profiles, seals, rings and/or hoses.

Another subject matter of the present invention is a tire, preferably a pneumatic tire or solid tire, or a rubber component or a rubber article, such as a technical rubber article, respectively produced employing the vulcanizable rubber composition according to the invention, the kit of parts according to the invention or the vulcanized rubber composition according to the invention, wherein preferably in the case of rubber components these are selected from base components, i.e., components under the tread, shoulder strips (wings), cap-plies, belts, beads and/or bead reinforcements, and wherein, in the case of rubber articles such as technical rubber articles, these preferably are selected from drive belts, straps/belts, molded parts such as buffers/cushions, bearings/mounts, such as hydromounts, conveyor belts, profiles, seals, rings and/or hoses.

Surprisingly, it has been found that the rubber composition according to the invention has high dynamic stiffness and at the same time a low tan delta value. With the better decoupling of these two properties, especially in comparison to rubber compositions containing industrial carbon black, a more flexible and better adjustment of the targeted performance of the rubber composition can be achieved.

Specifically, the combination of the filler employed according to the invention and the organosilane employed according to the invention leads to an improvement in the performance of the rubber composition. By the (partial) replacement of industrial carbon black with the filler employed according to the invention, the tan delta value can be reduced while the dynamic stiffness at least remains unchanged. Surprisingly, by the additional use of the organosilane employed according to the invention, a higher dynamic stiffness can also be achieved, in addition to a further reduction of the tan delta value. Further, it has surprisingly been found that by the combination of the filler employed according to the invention and of the organosilane employed according to the invention, often an equal to higher elongation at failure is achieved (as compared to vulcanized rubber compositions containing carbon black as the filler). Furthermore, the hardness of the rubber composition was not adversely affected. The combination of the filler employed according to the invention and of the organosilane employed according to the invention is advantageous in particular for rubber compositions cross-linked by means of sulfur.

The use of the filler according to the invention is also highly advantageous from an environmental point of view. During the production of industrial carbon black, large quantities of CO₂ are released in the production process. The filler according to the invention thus represents an environmentally friendly filler alternative, and moreover has—in contrast to industrial carbon black—no effect on the color of the rubber compositions.

### DETAILED DESCRIPTION

The term “comprising” as used in the present invention in connection with, for example, the vulcanizable rubber compositions according to the invention and the process steps or stages of processes described herein preferably has the meaning “consisting of.” In this context, for example, with regard to the vulcanizable rubber composition according to the invention, one or more of the further constituents optionally contained that are mentioned herein below may also be contained therein—in addition to the constituents mandatorily present therein. All the constituents may be present in each of their preferred embodiments mentioned below. With regard to the processes according to the invention and described herein, these may have further optional process steps and stages in addition to the mandatory steps and/or stages.

The amount of all the compositions described herein, such as the constituents contained in the vulcanizable rubber compositions according to the invention (comprising in each case all the mandatory constituents and, moreover, all the optional constituents), add up in total to 100% by weight in each case.

### Vulcanizable Rubber Composition

The vulcanizable rubber composition according to the invention comprises a rubber component K, a filler component F and a vulcanization system VS, wherein
the vulcanization system VS comprises at least sulfur and/or at least one sulfur donor,
the rubber component K contains at least one rubber that is cross-linkable by means of sulfur,
the filler component F contains at least one organic filler that has a ¹⁴C content in a range from 0.20 to 0.45 Bq/g of carbon and a BET surface area in a range from 20 to 150 m²/g, preferably from >20 to 150 m²/g, and
the vulcanizable rubber composition further comprises at least one organosilane as a part of the filler component F, wherein the at least one organosilane has at least one hydrolysable group and at least one sulfur atom, and the at least one organosilane is contained preferably in a quantity lying in a range from 0.25 to 5 phr.

### Rubber Component K

The rubber component K of the vulcanizable rubber composition according to the invention comprises at least one rubber that is cross-linkable by the vulcanization system VS comprising at least sulfur.

Any kind of rubber is suitable for the production of the rubber composition according to the invention, as long as it can be cross-linked by means of sulfur. Suitable rubbers are diene rubbers, in particular diene rubbers selected from the group consisting of natural rubber (NR), synthetical natural rubber, in particular isoprene rubber (IR), styrene butadiene rubber (SBR), solution-polymerized styrene butadiene rubber (SSBR), emulsion-polymerized styrene butadiene rubber (ESBR), functionalized SBR, in particular functionalized SSBR, butadiene rubber (BR), chloroprene rubber (CR), acrylonitrile butadiene rubber (NBR; nitrile rubber), isobutylene isoprene rubber (IIR), brominated isobutylene isoprene rubber (BIIR), chlorinated isobutylene isoprene rubber (CIIR), as well as mixtures thereof.

Preferably, a functionalized diene rubber such as SSBR has one or more functional groups in one or more side chains and/or end groups, wherein the at least one functional group preferably is selected from polar groups, in particular selected from the group consisting of carboxyl, hydroxy, amino, carboxylic acid ester, carboxylic acid amide or sulfonic acid groups and mixtures thereof. Functionalized SSBR is known from the patent application DE 10 2008 052 116 A1, among others.

Preferably, the at least one rubber of the rubber component K is a natural rubber, solution-polymerized styrene butadiene rubber (SSBR), emulsion-polymerized styrene butadiene rubber (ESBR) or butadiene rubber, or a mixture of at least two of the above-mentioned rubbers. Particularly preferred as the rubber of the rubber component K is a natural rubber.

### Vulcanization System VS

The vulcanization system VS of the vulcanizable rubber composition according to the invention comprises at least sulfur and/or at least one sulfur donor. The sulfur donor releases sulfur under vulcanization conditions. Sulfur serves as a cross-linking agent for polymers, both if it is directly contained in the vulcanization system VS and also after being released from the sulfur donor used.

By the presence of the vulcanization system VS and the sulfur contained therein, and/or the at least one sulfur donor, the vulcanizable rubber compositions according to the invention can be vulcanized.

Typically, elemental sulfur in the form of S₈ rings is used for the cross-linking by means of sulfur. The S₈ ring is either opened thermically or by alkaline substances. The sulfur may be present in the rubber composition as soluble or insoluble sulfur. The term accelerator refers to alkaline organic compounds that activate the ring opening. As an alternative or in addition to elemental sulfur, at least one sulfur donor may be employed. In this case, sulfur is released from such sulfur donors during vulcanization only. Examples for sulfur donors are sulfur-containing chemical compounds such as 4.4′-dithiomorpholine (DTDM) and tetramethyl thiuram disulfide (TMTD), which can be employed in dosages in a range from 0.5 to 2.0 phr, for example in a quantity of 1.5 phr (DTDM) or of 1.0 phr (TMTD).

The proportion of sulfur in the rubber composition according to the invention is preferably in a range from 0.25 to 10 phr, particularly preferably 0.25 to 7 phr, more particularly preferably 0.5 to 5 phr, most preferably 1 to 3 or to 2 phr.

Preferably, the vulcanization system VS comprises at least one accelerator for the cross-linking by means of sulfur. The sulfur donors cited above are also suitable as such accelerators if the vulcanization system VS contains sulfur as the cross-linking agent. Preferably, the at least one accelerator is selected from the group consisting of dithiocarbamates, xanthogenates, thiurams such as thiuram monosulfide and/or thiuram disulfide and/or tetrabenzyl thiuram disulfide (TbzTD) and/or tetramethyl thiuram disulfide (TMTD), thiazoles such as 2-mercaptobenzothiazole and/or dibenzothiazyl disulfide, sulfenamides such as N-cyclohexyl-2-benzothiazyl-sulfenamide (CBS) and/or 2-morpholinothiobenzothiazole and/or N-tert-butyl-2-benzothiazyl sulfenamide, guanidines such as N,N′-diphenylguanidine, thioureas, dithiophosphates, dipentamethylene thiuram tetrasulfide, 4,4′-dithiodimorpholine (DTDM), caprolactam disulfide, and mixtures thereof, and more particularly preferably is selected from the group consisting of N-tert-butyl-2-benzothiazyl-sulfenamide, tetrabenzyl thiuram disulfide and N, N′-diphenylguanidine as well as mixtures thereof.

The proportion of the at least one accelerator in the rubber composition according to the invention preferably is 0.1 to 10 phr, particularly preferably 0.2 to 8 phr, more particularly preferably 0.2 to 6 phr, most preferably 0.2 to 3 phr.

The vulcanization system VS of the vulcanizable rubber composition according to the invention may contain other vulcanizing agents then sulfur and/or sulfur donors, and/or additives promoting vulcanization such as zinc oxide and/or fatty acids, such as, e.g., stearic acid.

The vulcanization system VS of the vulcanizable rubber composition according to the invention may contain one or more additives that promote vulcanization, but cannot initiate it by themselves. Such additives include, for example, vulcanization accelerators such as saturated fatty acids with preferably 12 to 24, particularly preferably 14 to 20 and most preferably 16 to 18 carbon atoms, such as stearic acid and the zinc salts of the aforementioned fatty acids.

If additives promoting vulcanization, and in particular the above-mentioned fatty acids and/or their zinc salts, preferably stearic acid and/or zinc stearate, are employed in the rubber compositions according to the invention, their proportion is preferably 0 to 10 phr, particularly preferably 1 to 8 phr and most preferably 1.5 to 5 phr.

The vulcanization system VS of the vulcanizable rubber composition according to the invention may moreover contain one or more further vulcanizing agents that differ from sulfur and/or sulfur donors, such as preferably zinc oxide. It is particularly preferred to employ such vulcanizing agents of the vulcanization system VS in addition to sulfur and/or sulfur donors.

If other vulcanizing agents such as zinc oxide are employed in the rubber compositions according to the invention, their proportion preferably is 0 to 10 phr, particularly preferably 1 to 8 phr and most preferably 2 to 5 phr.

It is also possible to add peroxide as another cross-linking agent to the vulcanization system VS, in addition to at least the sulfur used and/or the at least one sulfur donor. This, however, in not preferred.

Vulcanization of the rubber composition of the present invention preferably is effected using sulfur and/or the at least one sulfur donor, particularly preferably using sulfur in combination with zinc oxide and/or at least one fatty acid, particularly preferably using sulfur and/or the at least one sulfur donor, more particularly preferably using sulfur in combination with zinc oxide and at least one fatty acid.

### Filler Component F

The filler component F of the vulcanizable rubber composition according to the invention comprises at least one organic filler. Since the filler employed according to the invention filler is of organic nature, inorganic fillers such as precipitated silicas do not fall under this category.

The terms filler and organic filler in particular are known to the person skilled in the art. Preferably, the organic filler employed according to the invention is a reinforcing filler, i.e., an active filler. Reinforcing or active fillers are characterized by a higher specific surface area than inactive fillers and, in contrast to inactive (non-reinforcing) fillers, they can change the viscoelastic properties of a rubber by interacting with the rubber within a rubber composition. For example, they can influence the viscosity of the rubbers and can improve elongation under tension and the fracture behavior of the vulcanizates, for example with regard to tear strength, tear propagation resistance and abrasion. Inactive fillers, on the other hand, dilute the rubber matrix and lead, for example, to a reduction in fracture energy.

The organic filler employed according to the invention has a ¹⁴C content in a range from 0.20 to 0.45 Bq/g of carbon, preferably 0.23 to 0.42 Bg/g of carbon. The required ¹⁴C content cited above is achieved by organic fillers obtained from biomass, by further treatment or reaction, preferably by fractioning, wherein the fractioning can be carried out thermally, chemically and/or biologically, and preferably is carried out thermally and chemically. Thus, fillers obtained from fossil materials, such as fossil fuels in particular, do not fall under the definition according to the present invention of the fillers to be used according to the invention, since they do not possess a corresponding ¹⁴C content.

Biomass is in principle defined herein as any biomass, wherein the term “biomass” herein includes so-called phytomass, i.e., biomass originating from plants, zoomass, i.e., biomass originating from animals, and microbial biomass, i.e., biomass originating from microorganisms including fungi, the biomass is dry biomass or fresh biomass, and it originates from dead or living organisms. The biomass particularly preferred herein for the production of the fillers is phytomass, preferably dead phytomass. Dead phytomass comprises, among other things, dead, rejected or detached plants and their parts. These include, for example, broken and torn leaves, cereal stalks, side shoots, twigs and branches, the fallen leaves, felled or pruned trees, as well as seeds and fruits and parts derived therefrom, but also sawdust, wood shavings/chips and other products derived from wood processing.

The organic filler employed according to the invention has a BET surface area (specific total surface area according to Brunauer, Emmett and Teller) in a range from 20 to 150 m²/g, preferably in a range from >20 to 150 m²/g, particularly preferably in a range from 25 to 120 m²/g, in particular preferably in a range from 30 to 110 m²/g, most preferably in a range from 40 to 100 m²/g. One method for the determination of the BET surface area is cited in the Methods section hereinbelow.

Preferably, the organic filler has an oxygen content in a range from >8% by weight to <30% by weight, particularly preferably from >10% by weight to <30% by weight, more particularly preferably from >15% by weight to <30% by weight, most preferably from >20% by weight to <30% by weight, relative to the ash-free and water-free filler, respectively. The oxygen content can be determined by high-temperature pyrolysis, for example using the EuroEA3000 CHNS-O Analyzer of the company EuroVector S.p.A.

Preferably, the organic filler has a carbon content in a range from >60% by weight to <90% by weight, particularly preferably from >60% by weight to <85% by weight, more particularly preferably from >60% by weight to <82% by weight, most preferably from >60% by weight to <80% by weight, relative to the ash-free and water-free filler, respectively. One method for the determination of the carbon content is cited in the

Methods section hereinbelow. In this respect, the organic filler differs both from carbon blacks, such as industrial carbon blacks, made of fossil raw materials, as well as from carbon blacks made of regrowing raw materials, since carbon blacks have a corresponding carbon content of at least 95% by weight.

Preferably, the organic filler has an STSA surface area in a range from >18 to <150 m²/g, particularly preferably in a range from 20 to 130 m²/g, more particularly in a range from 25 to 120 m²/g, even more preferably in a range from 30 to 110 m²/g, in particular in a range from 40 to 100 m²/g, most preferably in a range from 40 to <100 m²/g. A method for the determination of the STSA surface area (Statistical Thickness Surface Area) is cited in the Methods section hereinbelow.

Preferably, the organic filler has at least one functional group that is selected from phenolic OH groups, phenolate groups, aliphatic OH groups, carboxylic acid groups, carboxylate groups and mixtures thereof.

Preferably, the organic filler employed according to the invention is a lignin-based organic filler produced from biomass and/or biomass components. For example, the lignin for the production of the lignin-based organic filler may be isolated and extracted from biomass and/or dissolved. Suitable processes for obtaining the lignin for the production of the lignin-based organic filler from biomass are, for example, hydrolytic processes or pulping processes, such as the Kraft pulping process. The term “lignin-based” as used in the present invention preferably means that one or more lignin moieties and/or one or more lignin scaffolds are present in the organic filler employed according to the invention. Lignins are solid biopolymers that are incorporated into plant cell walls and thus effect the lignification of plant cells. As such, they are present in biomass and in particular in biologically regrowing raw materials, and they therefore represent—in particular in hydrothermally treated form—an environmentally friendly filler alternative.

Preferably, the lignin, and preferably the organic filler employed according to the invention as such, if it is a lignin-based filler, is present at least partially in hydrothermally treated form, and is particularly preferably obtainable by means of hydrothermal treatment, respectively. Particularly preferably, the organic filler employed according to the invention is based on lignin that can be obtained by hydrothermal treatment. Suitable processes for the hydrothermal treatment, in particular of lignins and lignin-containing organic fillers, are described in WO 2017/085278 A1 and WO 2017/194346 A1 as well as in EP 3 470 457 A1, for example. Preferably, the hydrothermal treatment is carried out at temperatures of >100° C. to <300° C., particularly preferably >150° C. to <250° C., in the presence of liquid water. Preferably, the organic filler is a lignin-based filler, wherein preferably at least the lignin and even more preferably, the organic filler as such, is present at least partially in a form that can be obtained by means of hydrothermal treatment, and particularly preferably can be obtained by means of hydrothermal treatment, wherein the hydrothermal treatment preferably has been carried out at a temperature in a range from >100° C. to <300° C., particularly preferably from >150° C. to <250° C.

Preferably, the organic filler has a pH value in a range from 7 to 9, particularly preferably in a range from >7 to <9, more particularly preferably in a range from >7.5 to <8.5.

The organic filler employed according to the invention preferably has a d99 value of <25 μm, even more preferably <20 μm, particularly preferably <18 μm, more particularly preferably <15 μm, even more preferably <12 μm, even more preferably <10 μm, even more preferably <9 μm, still more preferably <8 μm. The method for the determination of the d99 value is described hereinbelow in the Methods section and is carried out by means of laser diffraction according to ISO 13320:2009. The d90 and d25 values cited hereinafter are also determined in the same way. The person skilled in the art will be aware that the organic filler employed according to the invention is present in the form of particles, and that the average particle size (average grain size) of these particles is described by the aforementioned d99 value, and by the d90 and d25 values also mentioned above.

Particularly preferably, the organic filler employed according to the invention has a d99 value of <9 μm, even more preferably of <8 μm, preferably determined by means of laser diffraction according to ISO 13320:2009, respectively.

Preferably, the organic filler has a d90 value of <7.0 μm, particularly preferably of <6.0 μm, and/or preferably has a d25 of <3.0 μm, particularly preferably of <2.0 μm, preferably determined by means of laser diffraction according to ISO 13320:2009, respectively.

Preferably, the rubber composition according to the invention contains the at least one organic filler in a quantity lying in a range from 1 to 150 phr, particularly preferably from 5 to 100 phr, more particularly preferably from 10 to 80 phr, even more preferably from 15 to 70 phr, most preferably 15 to 60 phr.

The phr (parts per hundred parts of rubber by weight) specification used herein is the quantity specification commonly used in the rubber industry for compound formulations. The dosage of the parts by weight of the individual constituents is always based on the 100 parts by weight of the total mass of all rubbers present in the compound.

In addition to the at least one organic filler employed according to the invention, the filler component F may contain one or more other fillers that differ from the organic filler employed according to the invention.

In the case that the organic filler employed according to the invention serves only as a partial replacement of common industrial carbon blacks, the rubber compositions according to the invention may also contain industrial carbon blacks, in particular furnace carbon blacks, as classified as general-purpose carbon blacks under ASTM Code N660 or under ASTM Code N550, for example.

In addition or as an alternative, the rubber compositions according to the invention can contain in particular inorganic fillers, for example those having different particle size, particle surface and chemical nature with different potential to influence specific properties, but in particular the processing behavior (rheology). In the event that further fillers are included, these should preferably have properties as similar as possible to the organic fillers used in the rubber composition according to the invention, especially with regard to their pH values.

If other fillers are employed, they are preferably phyllosilicates such as clay minerals, for example talc; carbonates such as calcium carbonate; silicates such as for example calcium, magnesium and aluminum silicates; and oxides such as for example magnesium oxide and silica or silicic acid.

In particular in the case that the organic filler employed according to the invention serves only as a partial replacement for common silicic acids or silica, the rubber compositions according to the invention may also contain such inorganic fillers such as silica or silicic acid.

However, in the context of the present invention, zinc oxide does not fall under the inorganic fillers, since zinc oxide is taking the task of an additive promoting vulcanization. Additional fillers must be chosen with care, however, since silica tends to bind organic molecules to its surface and thus inhibit their action.

### Organosilane

The at least one organosilane of the vulcanizable rubber composition according to the invention has at least one hydrolysable group and at least one sulfur atom. Preferably, the at least one sulfur atom is part of a non-hydrolysable organic radical of the organosilane, or is covalently bound to such radical in the form of a functional group, such as a thiol group, and in particular the at least one sulfur atom is part of an aliphatic organic radical of the organosilane, or is covalently bound to such radical in the form of a functional group, such as a thiol group.

Preferably, the at least one organosilane of the vulcanizable rubber composition according to the invention is a compound of the general formula (I) and/or (II)

Si(X)_{4-y}(R)_{y} (i),

(X)_{3-z}(T)_{z}Si-(RA)-Si(X)_{3-z}(T)_{z} (II)
wherein, in the case of the general formula (I),
X respectively and independently from one another represents a hydrolysable group that is reactive with phenolic OH groups, phenolate groups, aliphatic OH groups, carboxylic acid groups, carboxylate groups and/or mixtures of these groups, the hydrolysable group respectively and independently from one another representing an alkoxy group, and particularly preferably being selected from O—C₁₋₄ alkyl,
the parameter y represents an integer in the range of 1 to 3, however is at least 1, and preferably is exactly 1, and
R represents a non-hydrolysable organic radical, preferably an aliphatic C₃ to C₂₀ radical having at least one sulfur atom, wherein the sulfur atom preferably is part of at least one functional group that preferably is selected from the group consisting of thiol groups, blocked thiol groups, di- and/or polysulfide groups such as tetrasulfide groups, as well as mixtures thereof, more particularly preferably thiol groups,
wherein, in the case of the general formula (II),
X respectively and independently from one another represents a hydrolysable group that is reactive with phenolic OH groups, phenolate groups, aliphatic OH groups, carboxylic acid groups, carboxylate groups and/or mixtures of these groups, the hydrolysable group independently from one another representing an alkoxy group, and particularly preferably being selected from O—C₁₋₄ alkyl,
RA represents a non-hydrolysable organic radical with two bonds, preferably an aliphatic C₆ to C₂₀ radical with two bonds that contains at least one sulfur atom, preferably at least one disulfide and/or polysulfide group, particularly preferably a di- or tetrasulfide group,
the parameter z respectively represents an integer in the range of 0 to 2, preferably means 0 or 2 respectively, and
T represents a non-hydrolysable organic radical that is different from the radical RA and has no functional groups, and preferably is an aliphatic C₁ to C₂₀ radical, and particularly preferably does not contain a sulfur atom.

In the case of monosilanes of the general formula (I), it is preferred that at least one radical R is a mercaptoalkyl group, wherein R preferably is an aliphatic C₃ to C₂₀ radical, particularly preferably an aliphatic C₃ to C₆ radical, and that the monosilane has at least one group X, preferably two or three groups X.

Preferably, the monosilane of the general formula (I) is selected from der group consisting of 4-mercaptobutyltrialkoxysilane and/or 6-mercaptohexyltrialkoxysilane and/or 3-mercaptopropyltrialkoxysilane, wherein alkoxy groups preferably mean, independently from one another, methoxy or ethoxy groups.

Preferably, the at least one organosilane is a compound of the general formula (II).

In the case of bis(silanes) of the general formula (II), it is preferred that the non-hydrolysable organic radical RA is an aliphatic C₆ to C₂₀ radical, particularly preferably an aliphatic C₆ to C₁₀ radical, and that RA has at least one sulfur atom. Particularly preferably, RA has a di- or polysulfide group, more particularly preferably a di- or tetrasulfide group. Preferably, the at least one sulfur atom is present within the radical RA, particularly preferably, the at least one sulfur atom is not adjacent to a silicon atom.

Preferably, the bis(silane) of the general formula (II) has at least one group X, particularly preferably two or three groups X.

Preferably, the bis(silane) of the general formula (II) is selected from the group consisting of bis(dimethylethoxysilylpropyl) tetrasulfide (DMESPT), bis(dimethylethoxysilylpropyl) disulfide (DMESPD), bis(triethoxysilylpropyl) tetrasulfide (TESPT), bis(triethoxysilylpropyl) disulfide (TESPD) and mixtures thereof, particularly preferably, the bis(silane) of the general formula (II) is TESPT and/or TESPD, most preferably it is TESPD.

Preferably, the at least one organosilane is contained in the vulcanizable rubber composition according to the invention in a quantity that lies in a range from 0.25 to 7 phr, particularly preferably 0.25 to 5 phr, more particularly preferably 0.5 to 3 phr.

Preferably, the at least one organosilane is contained in the vulcanizable rubber composition according to the invention in a quantity that lies, relative to the organic filler contained therein, in a range from 1 to 10% by weight, particularly preferably 2 to 8% by weight, more particularly preferably 2.5 to 6% by weight, most preferably 3 to 6 or to 5% by weight.

### Other Constituents of the Vulcanizable Rubber Composition

The rubber composition according to the invention may contain further optional constituents, such as plasticizers/softening agents and/or antidegradants and/or light stabilizing waxes and/or resins, in particular resins that increase adhesion.

By employing softening agents, it is possible to influence properties of the unvulcanized rubber composition, such as processability, in particular, but also properties of the vulcanized rubber composition, such as its flexibility, especially at low temperatures. Particularly suitable softening agents in the context of the present invention are mineral oils from the group of paraffinic oils (substantially saturated chain-shaped hydrocarbons) and naphthenic oils (substantially saturated ring-shaped hydrocarbons). It is also possible, and even preferred, to employ aromatic hydrocarbon oils. However, with regard to the adhesion of the rubber composition to other rubber-containing components in tires, such as for example the carcass, a mixture of paraffinic and/or naphthenic oils could also be advantageous as softening agent. Other possible softening agents are for example esters of aliphatic dicarboxylic acids, such as for example adipic acid or sebacic acid, paraffin waxes and polyethylene waxes. Among the softening agents, paraffinic oils and naphthenic oils are particularly suitable in the context of the present invention; most preferred are however aromatic oils, in particular aromatic mineral oils.

Preferably, softening agents, and among them particularly preferred the paraffinic and/or naphthenic and in particular aromatic process oils, are employed in a quantity of 0 to 10 phr, particularly preferably 1 to 8 phr, more particularly preferably 1 to 7 phr, most preferably 1 to 3 phr.

Preferably, chinolines such as TMQ (2,2,4-trimethyl-1,2-dihydrochinoline) and diamines such as 6-PPD (N-(1,3-dimethylbutyl)-N′-phenyl-p-phenylendiamine) or IPPD (N-isopropyl-N′-phenyl-p-phenylendiamine), are used as antidegradants, particularly preferably IPPD. Preferably, their proportion is 1 to 10 phr, particularly preferably 1 to 7 phr, more particularly preferably 1 to 5 phr, most preferably 1 to 2 phr.

Examples for light stabilizing waxes are Negozone 3457 from the H&R Group or the Antilux light stabilizing waxes from the company Rhein Chemie, such as Antilux 111 or Antilux 654. Preferably, their proportion is 0.25 to 10 phr, particularly preferably 0.5 to 7 phr, more particularly preferably 0.5 to 5 phr, most preferably 0.5 to 2 phr.

So-called adhesion-enhancing resins can be used to improve the adhesion of the vulcanized rubber compound of the present invention to other adjacent tire components. Particularly suitable resins are those based on phenol, preferably from the group consisting of phenolic resins, phenol-formaldehyde resins and phenol-acetylene resins. In addition to the phenolic-based resins, aliphatic hydrocarbon resins such as Escorez™ 1102 RM from the company ExxonMobil, as well as aromatic hydrocarbon resins, may also be used. Aliphatic hydrocarbon resins particularly improve adhesion to other rubber components of the tire. They generally have lower adhesion than the resins based on phenol and can be used either alone or as a mixture with the resins based on phenol.

If the adhesion-enhancing resins are used at all, then preferably those selected from the group consisting of resins based on phenol, aromatic hydrocarbon resins and aliphatic hydrocarbon resins. Preferably, their proportion is 0 to 15 phr, particularly preferably 1 to 15 phr, more particularly preferably 2 to 10 phr, most preferably 3 to 8 phr.

### Kit of Parts

Another subject of the present invention is a kit of parts, comprising, or preferably consisting of, in spatially separated form,
as part (A), a rubber composition containing at least the above-mentioned rubber component K employed according to the invention and at least the filler component F employed according to the invention, wherein part (A) does not comprise, however, sulfur and/or at least one sulfur donor of the vulcanization system VS employed according to the invention, and
as part (B), a vulcanization system VS employed according to the invention, comprising at least sulfur and/or at least one sulfur donor,
wherein the organosilane employed according to the invention is contained in the filler component F in part (A) preferably in a quantity lying in a range from 0.25 to 5 phr.

Thus, part (A) is not yet vulcanizable as such by means of sulfur, and thus at this point of time represents a rubber composition that is not vulcanizable by means of sulfur. The vulcanization by means of sulfur is only possible after mixing the parts (A) and (B), regardless of whether the sulfur is present per se and/or is only released from the at least one sulfur donor.

Preferably, the components K and F of the rubber composition according to the invention on the one hand and the vulcanization system VS on the other hand are spatially separated from each other in the kit of parts and can thus be stored. The kit of parts serves for the preparation of a vulcanizable rubber composition. Thus, for example, the rubber composition constituting the one part of the kit of parts comprising the components K and F and optionally other constituents, including vulcanizing agents different from sulfur, such as zinc oxide and/or at least one fatty acid, can be employed as part (A) in stage 1 of the process further described hereinbelow for preparing a vulcanizable rubber composition, and the second part of the kit of parts, namely the vulcanization system VS as part (B), comprising at least sulfur and/or at least one sulfur donor, can be employed in stage 2 of said process, the organosilane employed according to the invention being contained in the filler component F in part (A).

In contrast to the vulcanizable rubber composition that contains both the constituents K, F and an organosilane having at least one hydrolysable group and at least one sulfur atom, of the rubber composition according to the invention, as well as the associated vulcanization system VS comprising at least sulfur and/or at least one sulfur donor, preferably in a homogenous mixture, so that the vulcanizable rubber composition can be directly vulcanized, the rubber composition comprising the components K, F and preferably the organosilane having at least one hydrolysable group and at least one sulfur atom, and the vulcanization system VS comprising at least sulfur and/or at least one sulfur donor are thus spatially separated from one another in the kit of parts according to the invention.

All preferred embodiments described hereinabove in connection with the vulcanizable rubber composition according to the invention are also preferred embodiments with regard to the kit of parts according to the invention.

Preferably, the kit of parts according to the invention comprises, as
part (A) a rubber composition comprising at least the components K, F and one organosilane, which has at least one hydrolysable group and at least one sulfur atom, and as
part (B) a vulcanization system VS comprising at least sulfur and/or at least one sulfur donor and in addition zinc oxide, wherein the zinc oxide may alternatively be present within part (A).

Particularly preferably, the kit of parts according to the invention comprises, as
part (A) a rubber composition comprising at least the components K, F and one organosilane, which has at least one hydrolysable group and at least one sulfur atom, and as
part (B) a vulcanization system comprising at least sulfur and/or at least one sulfur donor, a zinc oxide and at least one saturated fatty acid such as stearic acid and/or optionally zinc stearate, wherein at least zinc oxide and/or the fatty acid may alternatively be present within part (A).

### Process for Preparing the Vulcanizable Rubber Composition

Another subject matter of the present invention is a process for preparing the vulcanizable rubber composition according to the invention.

All preferred embodiments described hereinabove in connection with the vulcanizable rubber composition according to the invention and the kit of parts according to the invention are also preferred embodiments with regard to the process according to the invention.

The preparation of the vulcanizable rubber composition according to the invention is carried out preferably in two stages, i.e. the stages 1 and 2.

In the first stage (stage 1), a rubber composition as a base mixture (masterbatch) is prepared first, by mixing all constituents employed for the preparation of the vulcanizable rubber composition according to the invention with each other, but without the sulfur and/or the at least one sulfur donor. In the second stage (stage 2), the sulfur and/or the at least one sulfur donor, and optionally additional constituents of the vulcanization system VS, are admixed to the rubber composition obtained after stage 1.

### Stage 1

Preferably, the at least one rubber contained in the rubber component K of the rubber composition according to the invention, as well as resins different therefrom that may optionally be employed, are provided. However, the latter may alternatively also be added subsequently together with further additives. Preferably, the rubbers have at least room temperature (23° C.) or are particularly preferably preheated to temperatures of at maximum 50° C., more particularly preferably at maximum 45° C., and especially preferably at maximum 40° C. Particularly preferably, the rubbers are pre-masticated for a short period of time before the other constituents are added. If inhibitors such as magnesium oxide are used for subsequent vulcanization control, they are preferably also added at this point of time.

Then at least one organic filler employed according to the invention, and optionally further fillers, are added, preferably with the exception of zinc oxide, since this is used as a constituent of the vulcanization system in the rubber compositions according to the invention, as mentioned hereinabove, and is therefore herein not regarded as a filler. The addition of the at least one organic filler and optionally other fillers preferably is carried out in increments.

Advantageously, but not mandatorily, softening agents, the organosilane employed according to the invention and other constituents such as vulcanizing agents other than sulfur, such as stearic acid and/or zinc stearate and/or zinc oxide, are added only subsequently to the addition of the at least one organic filler or the other fillers, if used. This facilitates the incorporation of the at least one organic filler, and if present, the other organic fillers. It may be advantageous, however, to incorporate a part of the organic filler, or, if present, the other fillers, together with the softening agents and any other constituents optionally used.

The highest temperatures obtained during the preparation of the rubber composition in the first stage (“dump temperature”) should not exceed 170° C., since there is the possibility of partial decomposition of the reactive rubbers and/or the organic fillers above these temperatures. Depending in particular from the rubber employed, temperatures of >170° C., for example up to 200° C., may however also be possible. Preferably, the maximum temperature in the preparation of the rubber composition of the first stage is between 80° C. and <200° C., particularly preferably between 90° C. and 190° C., most preferably between 95° C. and 170° C.

The mixing of the constituents of the rubber composition is usually carried out by means of internal mixers equipped with tangential or meshing (i.e., intermeshing) rotors. The latter usually allow for better temperature control. Mixers with tangential rotors are also referred to as tangential mixers. However, mixing can also be carried out using a double-roll mixer, for example. Depending on the rubber used, the mixing process can be carried out conventionally, starting with addition of the polymer, or upside down, that is, in the end after addition of all other constituents of the mixture.

After the preparation of the rubber composition is completed, it is preferably cooled down before carrying out the second stage. A process of this type is also referred to as relaxation. Typical relaxation periods are 6 to 24 hours, preferably 12 to 24 hours.

### Stage 2

In the second stage, at least sulfur and/or at least one sulfur donor, but preferably additional constituents of the vulcanization system VS, are incorporated into the rubber composition of the first stage, thereby obtaining a vulcanizable rubber composition according to the present invention. Preferably, the accelerators for the cross-linking by means of sulfur, if employed/present, are also incorporated in stage 2.

If zinc oxide and in addition optionally at least one saturated fatty acid such as stearic acid are employed as the vulcanization system in addition to sulfur and/or the at least one sulfur donor, the addition of all these constituents may take place in stage 2. It is however also possible to integrate these constituents, with the exception of sulfur and/or the at least one sulfur donor, into the rubber composition already in stage 1.

The highest temperatures obtained during the preparation of the admixture of the vulcanization system to the rubber composition in the second stage (“dump temperature”) should preferably not exceed 130° C., and particularly preferably not exceed 125° C. A preferred temperature range lies between 70° C. and 125° C., particularly preferably between 80° C. and 120° C. At temperatures above the maximal temperatures for the cross-linking system of 105° C. to 120° C., premature vulcanization might occur.

After admixing the vulcanization system in stage 2, the composition is preferably cooled down.

In the two-stage process mentioned hereinabove, a rubber composition is first obtained in the first stage that is then expanded to a vulcanizable rubber composition in the second stage.

### Process of Further Processing the Vulcanizable Rubber Composition According to the Invention

Before vulcanization, the vulcanizable rubber compositions thus prepared go through deformation processes that are preferably customized or tailored for the final articles. The rubber compositions are formed into a suitable shape as required for the vulcanization process, preferably by extrusion or calendering. The vulcanization may be carried out in vulcanization molds by means of pressure and temperature, or the vulcanization is carried out without pressure in temperature-controlled channels in which air or liquid materials provide heat transfer.

### Vulcanized Rubber Composition

Another subject matter of the present invention is a vulcanized rubber composition that can be obtained by vulcanization of the vulcanizable rubber composition according to the invention or by vulcanization of a vulcanizable rubber composition obtainable by combining and mixing the two parts (A) and (B) of the kit of parts according to the invention.

All preferred embodiments described hereinabove in connection with the vulcanizable rubber composition according to the invention and the kit of parts according to the invention as well as with the process according to the invention are also preferred embodiments with regard to the vulcanized rubber composition according to the invention.

Typically, vulcanization is carried out under pressure and/or under the effect of heat. Suitable vulcanization temperatures preferably are 100° C. to 200° C., particularly preferably 120° C. to 180° C. and most preferably 140° C. to 170° C. Optionally, vulcanization is carried out at a pressure in the range of 50 bar to 300 bar. It is however also possible to carry out the vulcanization in a pressure range from 0.1 bar to 1 bar, for example in the case of profiles. The closing pressure of the press is typically in a range from 150 bar to 500 bar, depending on the mixture and the product geometry.

### Use

Another subject matter of the present invention is a use of the vulcanizable rubber composition according to the invention, of the kit of parts according to the invention or the vulcanized rubber composition according to the invention for employment in the production of tires, preferably in the production of pneumatic tires and solid tires, and tire components, preferably in the production of such tire components for which a lowest possible tan delta value for the vulcanized rubber compositions used in their production is targeted, such as for example rubber compositions comprising natural rubber(s) and/or rubbers having a low glass transition temperature Tg, in particular in the production of tire components selected from the group of base components, i.e., components under the tread, shoulder strips (wings), cap-plies, belts, beads and/or bead reinforcements, or for employment in the production of rubber articles, such as technical rubber articles, preferably of drive belts, straps/belts, molded parts such as buffers/cushions, bearings/mounts, such as hydromounts, conveyor belts, profiles, seals, rings and/or hoses.

The term “technical rubber article” (also mechanical rubber goods, MRG) is known to the person skilled in the art. Examples for technical rubber articles are drive belts, straps/belts, molded parts such as buffers/cushions, bearings/mounts, in particular hydromounts, conveyor belts, profiles, seals, dampers and/or hoses.

All preferred embodiments described hereinabove in connection with the vulcanizable rubber composition according to the invention, the kit of parts according to the invention, the process according to the invention and the vulcanized rubber composition according to the invention are also preferred embodiments with regard to the abovementioned use according to the invention.

### Tires and Tire Components

Another subject matter of the present invention is a tire, preferably a pneumatic tire or solid tire, or a tire component, respectively produced employing the vulcanizable rubber composition according to the invention, the kit of parts according to the invention or the vulcanized rubber composition according to the invention, wherein preferably in the case of tire components, these are selected from base components, i.e. components under the tread, shoulder strips (wings), cap-plies, belts, beads and/or bead reinforcements,

All preferred embodiments described hereinabove in connection with the vulcanizable rubber composition according to the invention, the kit of parts according to the invention, the process according to the invention and the vulcanized rubber composition according to the invention as well as the use according to the invention are also preferred embodiments with regard to the abovementioned tires according to the invention.

### Rubber Article, in Particular Technical Rubber Article

Another subject matter of the present invention is a rubber article, in particular a technical rubber article, preferably selected from drive belts, straps/belts, molded parts such as buffers/cushions, bearings/mounts, in particular hydromounts, conveyor belts, profiles, seals, rings and/or hoses, produced by employing the vulcanizable rubber composition according to the invention, the kit of parts according to the invention, or the vulcanized rubber composition according to the invention.

All preferred embodiments described hereinabove in connection with the vulcanizable rubber composition according to the invention, the kit of parts according to the invention, the process according to the invention and the vulcanized rubber composition according to the invention as well as the use according to the invention are also preferred embodiments with regard to the preferably technical rubber articles according to the invention.

### Determination Methods

### 1. Determination of the ¹⁴C Content

The determination of the ¹⁴C content (content of biologically based carbon) is carried out by means of the radiocarbon method according to DIN EN 16640:2017-08.

### 2. Determination of the Particle Size Distribution

The particle size distribution can be determined by laser diffraction of the material dispersed in water (1% by weight in water) according to ISO 13320:2009, with an ultrasound treatment of 12000 Ws being carried out before the measurement. The volume fraction is specified, for example, as d99 in μm (the diameter of the grains of 99% of the volume of the sample is below this value). The values d90 and d25 (in μm) are determined in the same way.

### 3. Determination of Carbon Content

The carbon content is determined by elemental analysis according to DIN 51732:2014-7.

### 4. Determination of Oxygen Content

The oxygen content is determined by high-temperature pyrolysis using the EuroEA3000 CHNS-O analyzer of the company EuroVector S.p.A. In the process, the CHNS content is determined by means of the abovementioned analysis apparatus, and the oxygen is subsequently calculated as the difference (100-CHNS).

### 5. Determination of Dry Matter Content of the Organic Fillers Employed

The dry matter content of the sample was determined along the lines of DIN 51718:2002-06 as follows. For this purpose, the MA100 moisture balance from the company Sartorius was heated to a dry temperature of 105° C. The dry sample, if not already in powder form, was mortared or ground to a powder. Approximately 2 g of the sample to be measured was weighed on a suitable aluminum pan in the moisture balance and then the measurement was started. As soon as the weight of the sample did not change by more than 1 mg for 30 s, this weight was considered constant and the measurement was terminated. The dry matter content then corresponds to the displayed content of the sample in % by weight. At least one duplicate determination was performed for each sample. The weighted mean values were reported.

### 6. Determination of the pH Value of the Organic Fillers Employed

The pH was determined along the lines of ASTM D 1512 standard as follows. The dry sample, if not already in powder form, was mortared or ground to a powder. In each case, 5 g of sample and 50 g of fully deionized water were weighed into a glass beaker. The suspension was heated to a temperature of 60° C. with constant stirring using a magnetic stirrer with heating function and stirring flea, and the temperature was maintained at 60° C. for 30 min. Subsequently, the heating function of the stirrer was deactivated so that the mixture could cool down while stirring. After cooling, the evaporated water was replenished by adding fully deionized water again and stirred again for 5 min. The pH value of the suspension was determined with a calibrated measuring instrument. The temperature of the suspension should be 23° C. (+0.5° C.). A duplicate determination was performed for each sample and the averaged value was reported.

### 7. Determination of the Ash Content of the Organic Fillers

The water-free ash content of the samples was determined by thermogravimetric analysis in accordance with the DIN 51719 standard as follows: Before weighing, the sample was ground or mortared. Prior to ash determination, the dry substance content of the weighed-in material is determined. The sample material was weighed to the nearest 0.1 mg in a crucible. The furnace, including the sample, was heated to a target temperature of 815° C. at a heating rate of 9° K/min and then held at this temperature for 2 h. The furnace was then cooled to 300° C. before the samples were taken out. The samples were cooled to ambient temperature in the desiccator and weighed again. The remaining ash was correlated to the initial weight and thus the weight percentage of ash was determined. Triplicate determinations were performed for each sample, and the averaged value was reported.

### 8. Determination of the BET and STSA Surface Area of the Organic Fillers

The specific surface area of the filler to be investigated was determined by nitrogen adsorption according to the ASTM D 6556 (2019-01-01) standard provided for industrial carbon blacks. According to this standard, the BET surface area (specific total surface area according to Brunauer, Emmett and Teller) and the external surface area (STSA surface area; Statistical Thickness Surface Area) were also determined as follows.

The sample to be analyzed was dried to a dry matter content ≥97.5% by weight at 105° C. prior to the measurement. In addition, the measuring cell was dried in a drying oven at 105° C. for several hours before weighing in the sample. The sample was then filled into the measuring cell using a funnel. In case of contamination of the upper measuring cell shaft during filling, it was cleaned using a suitable brush or a pipe cleaner. In the case of strongly flying (electrostatic) material, glass wool was weighed in additionally into the sample. The glass wool was used to retain any material that might fly up during the bake-out process and contaminate the unit.

The sample to be analyzed was baked out at 150° C. for 2 hours, and the Al₂O₃ standard was baked out at 350° C. for 1 hour. The following N2 dosage was used for the determination, depending on the pressure range:

$$p / p 0 = 0 - 0.01 : {N}_{2} dosage : 5 ml / g$$

$$p / p 0 = 0.01 - 0.5 : {N}_{2} dosage : 4 ml / g .$$

To determine the BET surface, extrapolation was performed in the range of p/p0=0.05−0.3 with at least 6 measurement points. To determine the STSA, extrapolation was performed in the range of the layer thickness of the adsorbed N2 from t=0.4−0.63 nm (corresponding to p/p0=0.2-0.5) with at least 7 measurement points.

### 9. Determination of Hardness

The determination of the Shore A hardness of vulcanized rubber compositions was carried out in accordance with ISO 48-4:2018-08 at 23° C., using the digital Shore hardness tester from the company Sauter GmbH. In order to reach the thickness of the test specimen of at least 6 mm, as required by the standard, the test specimen was composed of not more than three layers. For this purpose, 3 S2 bars, punched out to perform the tensile test according to ISO 37:2011, were stacked on top of each other. Five measurements were taken on each sample stack at different points on the stack. The results obtained represent the average value of these five measurements.

Between vulcanization and testing, the samples were stored for at least 16 h at room temperature in the laboratory.

### 10. Determination of Cross-Linking Density/Reaction Kinetics

The cross-linking density and the reaction kinetics of the rubber compositions were determined according to DIN 53529-3:1983-06 at 160° C., but at a deflection of 0.5 or 3° (according to the value respectively given in the experimental part). The measuring time was 30 min. In the process, the minimum and the maximum torque (M_{L}, M_{H}) were determined. From these, the difference Δ (Δ(M_{H}−M_{L}) was calculated (maximum torque minus minimum torque). Furthermore, the time periods were determined in which the torque, starting from the time of the minimum torque M_{L}, reaches 10%, 50% and 90% of the maximum torque M_{H}, respectively. The time periods were designated as T₁₀, T₅₀ and T₉₀.

### 11. Determination of Elongation Under Tension

The elongation under tension, including tensile strength and elongation at break, was determined on the vulcanized rubber compositions according to ISO 37:2011.

### 12. Dynamic-Mechanical Thermal Analysis (DMTA), or Dynamic-Mechanical Analysis (DMA)

DMTA/DMA serves to characterize the viscoelastic behavior. Testing was carried out according to the standard DIN EN ISO 6721 1-12, in this case 6721-7 being used. The viscoelastic behavior was analyzed by means of the testing apparatus MCR 501 from the company Anton Paar. In the process, a vulcanized rubber composition was subjected to a sinusoidal oscillating stress in the range of linear-elastic deformation. The test was performed at the following parameters: Deformation: 1%; frequency: 10 Hz; type of stress: torsion; heating rate: 2 K/min.; heating sequence: −70° C. to +100° C. Amplitude and phase shift of the deformation were recorded and the viscoelastic behavior could be described using the complex and loss modulus as well as the mechanical loss factor tan δ.

Generally, the complex or dynamic modulus (G*) is defined as:

$${G}^{⋆} = G ‘ + {i}^{x} G “$$

with G′: storage modulus (real component, represents the elastic component)
G″: loss modulus (imaginary component; represents the viscous component)
i: imaginary number

The loss factor tan δ (tan delta) is defined as:

$$tan σ = G “ / G ‘$$

### 13. Material Density of the Filer Employed

The material density of the filer was determined by means of a helium pycnometer according to ISO 21687.

### EXAMPLES AND COMPARATIVE EXAMPLES

The following examples and comparative examples serve to explain the invention, but should not be interpreted restrictively.

### 1. Production of Organic Fillers Employed According to the Invention

1.1 As the first organic filler according to the invention, a lignin L1 obtainable by hydrothermal treatment was used.

The lignin L1 obtainable by hydrothermal treatment was produced according to the process for producing lignins that are obtainable by hydrothermal treatment, described in WO 2017/085278 A1.

For this purpose, a liquid containing lignin was provided. First, water and lignin are mixed, thus preparing a lignin-containing liquid with a content of organic dry mass of 15%. Subsequently, the lignin is largely dissolved in the lignin-containing liquid. For this purpose, the pH value is adjusted by adding NaOH. The preparation of the solution is promoted by intense mixing at 80° C. for 3 h. The lignin-containing liquid is subjected to a hydrothermal treatment, thus obtaining a solid matter. In the process, the solution prepared is heated to the reaction temperature of 220° C. with 2 K/min, which is then held over the reaction period of 8 h. Subsequently, cooling is performed. As a result, an aqueous suspension of solid matter is obtained. By filtration and washing, the solid matter is largely dewatered and washed. Subsequent drying and thermal treatment is carried out under nitrogen in a fluidized bed, wherein for drying the temperature was brought to 50° C. at 1.5 K/min and held for 2.5 h, and subsequently for thermal treatment the temperature was brought to 190° C. at 1.5 K/min and held for a period of 15 min and then cooled down again. The dried solid matter is de-agglomerated on a counter-jet mill with nitrogen to a d99 value <10 μm (determined according to the determination method described hereinabove).

1.2 As a second organic filler according to the invention, a lignin L2 was employed, which is obtainable by hydrothermal treatment and was prepared analogously to the process described in section 1.1 and can be employed as organic filler. In deviation from the process described under 1.1, however, the hydrothermal treatment was carried out in such a way that the produced lignin-containing solution was prepared with an organic dry mass content of 10% by weight. After addition of NaOH, the lignin-containing liquid was subjected to hydrothermal treatment, wherein it was heated with 1.5 K/min to a reaction temperature of 230° C., which was maintained for a reaction time of 1 h. In addition, the lignin-containing liquid was modified using formaldehyde before the hydrothermal treatment was carried out. Finally, the final grinding was carried out on a steam-jet mill.

1.3 In deviation from the process described under 1.1, however, the hydrothermal treatment was carried out in such a way that the produced lignin-containing solution was prepared with an organic dry mass content of 9.7% by weight. After addition of NaOH, the lignin-containing liquid was subjected to hydrothermal treatment, wherein it was heated with 1.5 K/min to a reaction temperature of 240° C., which was maintained for a reaction time of 2 h. In addition, the lignin-containing liquid was modified using formaldehyde before the hydrothermal treatment was carried out. Finally, the final grinding was carried out on a counter-jet mill with nitrogen.

1.4 The lignins L1, L2 and L3 obtainable by hydrothermal treatment were characterized as specified in the following Table 1.1 by means of the methods mentioned hereinabove.

TABLE 1.1
Properties of the lignins L1, L2 and L3 obtainable by hydrothermal
treatment

| Test | Unit | Lignin L1 | Lignin L2 | Lignin L3 |
|---|---|---|---|---|
| STSA | m²/g | 51.6 | 46.2 | 72.0 |
| BET | m²/g | 55.5 | 51.7 | 77.2 |
| ¹⁴C content | Bq/g C | 0.23 | n.d. | n.d. |
| Oxygen content | % by weight | 20.7 | n.d. | n.d. |
| Carbon content | % by weight | 72.7 | n.d. | n.d. |
| Ash content | % by weight | 3.4 | 2.6 | 2.4 |
| pH value | ./. | 9.0 | 8.4 | 7.5 |
| Dry substance content | % by weight | 97.9 | 97.4 | 98.5 |
| Material density | g/cm³ | 1.32 | n.d. | n.d. |
| d99 | μm | 5.51 | 6.15 | 7.14 |
| d90 | μm | 3.51 | 4.15 | 5.0 |
| d25 | μm | 0.80 | 0.73 | 1.35 |

n.d. = not determined

### 2. Production of Vulcanizable Rubber Compositions

Vulcanizable rubber compositions were prepared by means of a two-stage process.

In the first stage, a rubber composition as a base mixture (masterbatch) was prepared by compounding the constituents of the rubber composition according to the invention, comprising the rubber composition K, the filler component F and the organosilane. In the second stage, the constituents of the cross-linking system (vulcanization system VS) were admixed.

The vulcanizable rubber compositions with the organic filler L1 employed according to the invention, as well as the corresponding comparative rubber compositions with industrial carbon black as the sole filler, were prepared as follows:

### Stage 1

The natural rubber (NR) SMR 5 CV 60 from the trading firm Astlett Rubber was used as the rubber. When using industrial carbon black as the sole filler (comparative rubber composition VK1V1), it is added as a batch of 33.3% after 1:30 minutes (together with the additives used, such as zinc oxide, stearic acid and other additives; cf. the following Table 2.1), and as another batch of 33.3% after 3:30 minutes (together with 50% of the process oil used). After 5 minutes, the last batch of 33.3% of the industrial carbon black is added together with the remaining 50% of the process oil used. In case of the partial replacement of industrial carbon black by the filler employed according to the invention (comparative rubber composition VK1V2 and rubber composition according to the invention VK1B1), 100% of the industrial carbon black used are added together with the additives used after 1:30 minutes. After 3:30 minutes, 50% of the filler employed according to the invention is added (together with 50% of the process oil used), and another 50% after 5 minutes (together with another 50% of the process oil used, and in the case of the examples according to the invention VK1B1 also together with 100% of the sulfur-functional organosilane).

For all compositions, the constituents of the mixture were mixed dispersively and distributively until the mixing process was stopped after 10 min (in case of V1B1 only after 13 min) and the rubber composition was taken from the laboratory mixer. Under these mixing conditions, the rubber composition achieved a final temperature of 130° C. to 155° C. After the preparation of the rubber composition was completed, it was cooled down before carrying out the second stage (relaxation/storage).

By means of the stage 1 described hereinabove, a rubber composition employed according to the invention was obtained, containing a natural rubber (K1B1) as the rubber component K and lignin L1 obtainable by hydrothermal treatment as the organic filler of the filler component. Moreover, the rubber composition according to the invention K1B1 contained bis(triethoxysilylpropyl) disulfide (TESPD) as the sulfur-functional organosilane.

In addition, the comparative compositions K1V1 and K1V2 were obtained, which also contained a natural rubber as the rubber component K. Comparative composition K1V1 did contain neither lignin L1, but commercially available carbon black as the only organic filler of the filler component, nor any sulfur functional organosilane, while comparative composition K1V2 contained lignin L1, but no sulfur-functional organosilane.

The exact compositions of the vulcanizable rubber compositions can be seen from the following Table 2.1. The quantities are respectively given in phr (parts per hundred parts of rubber by weight).

### Stage 2

In the second stage, sulfur as the cross-linking agent as well as one (K1V1, K1V2) or more (K1B1) accelerators were incorporated into the rubber composition of the first stage, thus obtaining a vulcanizable rubber composition. A sulfur cross-linking agent and one or more sulfur accelerator systems as co-agents were added into the laboratory mixer and mixed together with the rubber composition from the first stage at a speed of 50 rpm for 5 minutes. Here, the final temperature was 90° C. to 100° C. After the cross-linking system was admixed, the resulting composition was cooled.

By means of the stage 2 described hereinabove, after addition of the vulcanization system VS consisting of cross-linker and accelerator, a vulcanizable rubber composition according to the invention was obtained (VK1B1), which can be vulcanized after completion of the performance of stage 2. In addition, two vulcanizable comparative rubber compositions were obtained in this way (VK1V1 and VK1V2), which can also be vulcanized after completion of the performance of stage 2. The exact compositions of the vulcanizable rubber compositions can be seen from the following Table 2.1.

TABLE 2.1
Vulcanizable rubber composition according to the invention
VK1B1 and comparative examples VK1V1 and VK1V2

| Constituents | VK1V1 | VK1V2 | VK1B1 |
|---|---|---|---|
| Natural rubber | 100 | 100 | 100 |
| Industrial carbon black | 55 | 30 | 30 |
| Organic filler L1 | — | 21 | 21 |
| Process oil | 2 | 2 | 2 |
| Zinc oxide | 3 | 3 | 3 |
| Organosilane | — | — | 0.65 |
| Stearic acid | 2 | 2 | 2 |
| Antiaging agent | 1.5 | 1.5 | 1.5 |
| Light stabilizing wax | 1 | 1 | 1 |
| Cross-linking agent | 1.5 | 1.5 | 1.57 |
| Accelerator B1 | 1.5 | 1.5 | 1.5 |
| Accelerator B2 | — | — | 0.3 |
| Accelerator B3 | — | — | 0.4 |

As the industrial carbon black, the commercially available product Carbon black N550 from the company Pentacarbon (distributor for Carbon Black) was employed. The organic filler L1 has already been described hereinabove.

Bis(triethoxysilylpropyl) disulfide (TESPD, Si 266) from the company Evonik was used as the sulfur-functional organosilane. As the process oil, a naphthenic softening agent from the company Hansen & Rosenthal was used. As the antiaging agent, N-isopropyl-N′-phenyl-p-phenylendiamine (IPPD) from the company Lehmann & Voss & Co., with the tradename Luvomax IPPD, was used, and as the light stabilizing wax Negozone 3457 F from the company Hansen & Rosenthal. As the cross-linking agent (sulfur), Struktol SU95 from the company Schill+Seilacher was used. As the accelerator, the products TBBS-80 (B1), TBzTD-70 (B2) and DPG-80 (B3) from the company Rhein Chemie were used. As zinc oxide, the product Weißsiegel from the company Brüggemann was used. As the stearic acid, the product Palmera B 1805 from the company Avokal-Heller was used.

The vulcanizable rubber compositions with the fillers L2 and L3 employed according to the invention, as well as the corresponding comparative rubber compositions with industrial carbon black as the sole filler, were prepared as follows:

### Stage 1

The natural rubber (NR) SMR 5 CV 60 from the trading firm Astlett Rubber was used as the rubber. When using industrial carbon black as the sole filler (comparative rubber compositions VK2V1 and VK2V2), it is added as a batch of 33.3% after 2:00 minutes (together with the additives used, such as zinc oxide, stearic acid and other additives; cf. the following Table 2.2), and as another batch of 33.3% after 3:00 minutes (together with 50% of the process oil used). After 5 minutes, the last batch of 33.3% of the industrial carbon black is added together with the remaining 50% of the process oil used. In case of the partial replacement of industrial carbon black by one of the fillers employed according to the invention (rubber compositions according to the invention VK2B1 and VK2B2), 50% of the industrial carbon black used are added together with the additives used after 2:00 minutes, and after 3:00 the remaining 50% of the industrial carbon black are added with 50% of the process oil used. After 5:00 minutes, 100% of the filler employed according to the invention are added together with 50% of the process oil used and 100% of the sulfur-functional organosilane. When the filler employed according to the invention is employed as the sole filler (rubber compositions according to the invention VK2B3, VK2B4 and VK2B5), it is added as a batch of 33.3% after 2:00 minutes (together with the additives used), and as another batch of 33.3% after 3:00 minutes (together with 50% of the process oil used). After 5 minutes, the last batch of 33.3% of the filler employed according to the invention is added together with another 50% of the process oil used and 100% of the organosilane employed according to the invention.

For all compositions, the constituents of the mixture were mixed dispersively and distributively until the mixing process was stopped after 16 min and the rubber composition was taken from the laboratory mixer. Under these mixing conditions, the rubber composition achieved a final temperature of 145° C. to 155° C. After the preparation of the rubber composition was completed, it was cooled down before carrying out the second stage (relaxation/storage).

By means of the stage 1 described hereinabove, five rubber compositions according to the invention were obtained which contained a natural rubber as the rubber component K and lignin L2 (K2B1 and K2B3) obtainable by hydrothermal treatment or lignin L3 (K2B2, K2B4 or K2B5) as the organic filler of the filler component.

Furthermore, the rubber compositions according to the invention K2B1, K2B2, K2B3, K2B4 and K2B5 contained bis(triethoxysilylpropyl) disulfide (TESPD) as the sulfur-functional organosilane.

In addition, the comparative compositions K2V1 and K2V2 were obtained, which also contained a natural rubber as the rubber component K, but no lignin L2 or L3, but commercially available carbon black exclusively as the organic filler of the filler component, and no sulfur-functional organosilane.

The exact compositions of the vulcanizable rubber compositions can be seen from the following Table 2.2. The quantities are respectively given in phr (parts per hundred parts of rubber by weight).

### Stage 2

In the second stage, one (K2V1) or two (K2V2, K2B1, K2B2, K2B3, K2B4 and K2B5) accelerators were incorporated into the rubber composition of the first stage as the cross-linking agent, thus respectively obtaining a vulcanizable rubber composition. A sulfur cross-linking agent and one or two sulfur accelerator systems as co-agents were added into the laboratory mixer and mixed together with the rubber composition from the first stage at a speed of 50 rpm 5 minutes. Here, the final temperature was 90° C. to 100° C. After the cross-linking system was admixed, the resulting composition was cooled.

By means of the stage 2 described hereinabove, after addition of the vulcanization system VS consisting of cross-linker and accelerator, five vulcanizable rubber composition according to the invention were obtained (VK2B1, VK2B2, VK2B3, VK2B4 and VK2B5), which can be vulcanized after completion of the performance of stage 2. In addition, two vulcanizable comparative rubber compositions were obtained in this way (VK2V1 and VK2V2), which can also be vulcanized after completion of the performance of stage 2. The exact compositions of the vulcanizable rubber compositions can be seen from the following Table 2.2.

TABLE 2.2
Vulcanizable rubber compositions according to the invention VK2B1, VK2B2,
VK2B3, VK2B4 and VK2B5, as well as comparative examples VK2V1 and VK2V2

| Constituents | VK2V1 | VK2V2 | VK2B1 | VK2B2 | VK2B3 | VK2B4 | VK2B5 |
|---|---|---|---|---|---|---|---|
| Natural rubber | 100 | 100 | 100 | 100 | 100 | 100 | 100 |
| Industrial carbon | 50 | 50 | 30 | 30 | — | — | — |
| black | | | | | | | |
| Organic filler L2 | — | — | 20 | — | 50 | — | — |
| Organic filler L3 | — | — | — | 20 | — | 50 | 50 |
| Process oil | 2 | 2 | 2 | 2 | 2 | 2 | 2 |
| Zinc oxide | 5 | 5 | 5 | 5 | 5 | 5 | 5 |
| Organosilane | — | — | 0.7 | 1.1 | 1.72 | 2.75 | 2.75 |
| Stearic acid | 2 | 2 | 2 | 2 | 2 | 2 | 2 |
| Antiaging agent | 1.5 | 1.5 | 1.5 | 1.5 | 1.5 | 1.5 | 1.5 |
| Light stabilizing | 1 | 1 | 1 | 1 | 1 | 1 | 1 |
| wax | | | | | | | |
| Cross-linking | 1.5 | 1.7 | 1.77 | 1.8 | 1.88 | 2.0 | 2.3 |
| agent | | | | | | | |
| Accelerator B1 | 1.5 | 1.5 | 1.5 | 1.5 | 1.5 | 1.5 | 1.5 |
| Accelerator B3 | — | 0.6 | 0.6 | 0.6 | 1.0 | 1.0 | 1.0 |

As the constituents natural rubber, industrial carbon black, process oil, organosilane, zinc oxide, stearic acid, cross-linking agent, light stabilizing wax, antiaging agent and accelerator B1 and B2, as given in Table 2.2, the products already described in connection with Table 2.1 were used. The organic fillers L2 and L3 have already been described hereinabove.

### 3. Examinations and Tests of the Vulcanizable Rubber Compositions and the Vulcanized Compositions Obtainable Therefrom

### 3.1 Cross-Linking Density and Reaction Kinetics

The rubber compositions obtained after stage 2 were examined with regards to the properties of their raw mixtures. In the process, the reaction kinetics and the cross-linking density were measured according to the methods described hereinabove.

Table 3.1 summarizes the results obtained with regard to minimum and maximum torque (M_{L}, M_{H}), difference Δ (M_{H}−M_{L}) and the time periods T₁₀, T₅₀ and T₉₀ for the comparative examples VK1V1 and VK1V2 as well as for the rubber composition VK1B1 vulcanized according to the invention. The values were determined at a deflection of 3° C.

TABLE 3.1

| Parameters | VK1V1 | VK1V2 | VK1B1 |
|---|---|---|---|
| T₁₀ [min] | 1.51 | 1.29 | 1.29 |
| T₅₀ [min] | 2.13 | 1.92 | 1.61 |
| T₉₀ [min] | 3.34 | 3.67 | 2.41 |
| M_{L} [dNm] | 4.07 | 5.16 | 4.80 |
| M_{H} [dNm] | 43.47 | 32.97 | 37.62 |
| Δ (M_{H}-M_{L}) [dNm] | 39.40 | 27.81 | 32.82 |

The rubber composition according to the invention VK1B1 shows similar reaction kinetics (T₁₀, T₅₀, T₉₀) as the comparative examples VK1V1 and VK1V2. Minor deviations occur in the cross-linking density, which represents the difference Δ (M_{H}−M_{L}) from the maximum and minimum torque in dNm.

Table 3.2 summarizes the results obtained with regard to minimum and maximum torque (M_{L}, M_{H}), difference Δ (M_{H}−M_{L}) and the time periods T₁₀, T₅₀ and T₉₀ for the comparative examples VK2V1 and VK2V2 as well as for the rubber compositions VK2B1, VK2B2, VK2B3, VK2B4 and VK2B5 vulcanized according to the invention. The values were determined at a deflection of 0.5° C.

TABLE 3.2

| Parameters | VK2V1 | VK2V2 | VK2B1 | VK2B2 | VK2B3 | VK2B4 | VK2B5 |
|---|---|---|---|---|---|---|---|
| T₁₀ [min] | 2.13 | 1.47 | 2.02 | 2.11 | 3.71 | 2.81 | 2.8 |
| T₅₀ [min] | 2.98 | 2.03 | 2.8 | 2.94 | 4.69 | 4.18 | 4.11 |
| T₉₀ [min] | 4.75 | 3.32 | 4.63 | 5.02 | 7.03 | 8.23 | 7.83 |
| M_{L} [dNm] | 0.99 | 1.12 | 1.45 | 2.23 | 1.93 | 3.97 | 3.75 |
| M_{H} [dNm] | 13.9 | 16.86 | 15.52 | 14.78 | 12.43 | 12.86 | 13.55 |
| Δ (M_{H} − M_{L}) [dNm] | 12.91 | 15.74 | 14.07 | 12.55 | 10.5 | 8.89 | 9.8 |

The rubber compositions according to the invention VK2B1 and VK2B2, which are characterized by the partial replacement of carbon black with lignin-based filler L2 or L3, show similar or improved reaction kinetics (T₁₀, T₅₀, T₉₀) as compared to the comparative examples VK2V1 and VK2V2. The rubber compositions according to the invention VK2B3, VK2B4 and VK2B5, characterized by complete replacement of carbon black with lignin-based filler L2 or L3, show an increased incubation time (better scorch time), which leads to a longer T₉₀ value as compared to the case of the comparative examples VK2V1 and VK2V2.

### 3.2 Tensile Strength, Elongation at Failure and Shore a Hardness

The rubber compositions K1V1, K1V2 and K1B1 obtained were all vulcanized at 160° C., with the vulcanization times adapted to the reaction kinetics of the respective mixture. The vulcanization time for mixture VK1V1 was 6 min, for mixture VK1V2 7 min, for mixture VK1B1 5 min. Subsequently, tensile strength, elongation at failure, and Shore A hardness were determined according to the methods described hereinabove.

Table 3.3 summarizes the results obtained for the comparative examples VK1V1 and VK1V2 as well as for the rubber composition VK1B1 vulcanized according to the invention.

TABLE 3.3

| Parameters | VK1V1 | VK1V2 | VK1B1 |
|---|---|---|---|
| Tensile strength [MPa] | 25.99 | 22.29 | 24.09 |
| Elongation at break [%] | 480 | 544 | 539 |
| Shore A | 66 | 62 | 64 |

The rubber composition according to the invention VK1B1 has a similar tensile strength to the comparative rubber compositions VK1V1 and VK1V2. By the partial replacement of the industrial carbon black with the organic filler L1 and by the addition of the sulfur-functional organosilane, an equal hardness (Shore A) and an equal elongation at break was achieved.

The obtained rubber compositions K2V1, K2V2 as well as K2B1, K2B2, K2B3, K2B4 and K2B5 were all vulcanized at 160° C., wherein the vulcanization times were adapted to the data of the reaction kinetics of the respective mixture. The vulcanization time for the mixture VK2V1 was 7 min, for the mixture VK2V2 6 min, for the mixture VK2B1 7 min, for the mixture VK2B2 7 min, for the mixture VK2B3 9 min, for the mixture VK2B4 11 min and for the mixture VK2B5 10 min. Subsequently, tensile strength, elongation at failure, and Shore A hardness were determined according to the methods described hereinabove.

Table 3.4 summarizes the results obtained for the comparative examples VK2V1 and VK2V2 as well as for the rubber compositions VK2B1, VK2B2, VK2B3, VK2B4 and VK2B5 vulcanized according to the invention.

TABLE 3.4

| Parameters | VK2V1 | VK2V2 | VK2B1 | VK2B2 | VK2B3 | VK2B4 | VK2B5 |
|---|---|---|---|---|---|---|---|
| Tensile strength | 25.2 | 27.4 | 24.8 | 23.1 | 19.9 | 14.3 | 14.0 |
| [MPa] | | | | | | | |
| Elongation at | 486 | 501 | 515 | 507 | 520 | 429 | 410 |
| break [%] | | | | | | | |
| Shore A | 60 | 63 | 63 | 63 | 60 | 67 | 67 |

As compared to the comparative rubber compositions VK1V1 and VK1V2, the rubber compositions according to the invention VK2B1, VK2B2, VK2B3, VK2B4 and VK2B5 show a similar or decreasing tensile strength in the case of partial or complete replacement of carbon black with lignin-based fillers L2 or L3, whereas the hardness (Shore A) remains unchanged or increases.

### 3.3 Dynamic-Mechanical Thermal Analysis (DMTA)

The vulcanized rubber compositions were analyzed by means of a dynamic-mechanical thermal analysis (DMTA) according to the method described hereinabove in order to characterize its viscoelastic behavior. Table 3.5 summarizes the results obtained for the comparative examples VK1V1 and VK1V2 as well as for the rubber composition VK1B1 vulcanized according to the invention.

TABLE 3.5

| Parameters | VK1V1 | VK1V2 | VK1B1 |
|---|---|---|---|
| Storage modulus G′ at 60° C. | 3.11 | 3.16 | 3.55 |
| [MPa] | | | |
| Complex modulus G* at 60° C. | 3.15 | 3.20 | 3.58 |
| [MPa] | | | |
| Loss factor tan delta at 60° C. | 0.169 | 0.153 | 0.133 |

For a vulcanized rubber composition, it is basically desirable to achieve a highest possible dynamic stiffness and a lowest possible tan delta value. One key FIGURE for the dynamic stiffness is the complex modulus G*. The vulcanized rubber composition VK1B1 according to the invention shows an increased stiffness as compared to the comparative examples VK1V1 and VK1V2. Usually, a high dynamic stiffness G* (60° C.) leads to an increased loss factor tan delta. However, low heat generation and thus low tan delta values are preferred. Surprisingly, by the partial replacement of industrial carbon black with the organic filler L1 in combination with the addition of the sulfur-functional organosilane, an opposite effect was observed, since at an increased stiffness G* (60° C.), a reduction of the loss factor occurred simultaneously (cf. VK1B1 vs. VK1V1 and VK1V2).

Consequently, the use of the organic filler L1 in combination with the organosilane can reduce heat generation while at the same time increasing dynamic stiffness. Furthermore, an equal hardness could be achieved.

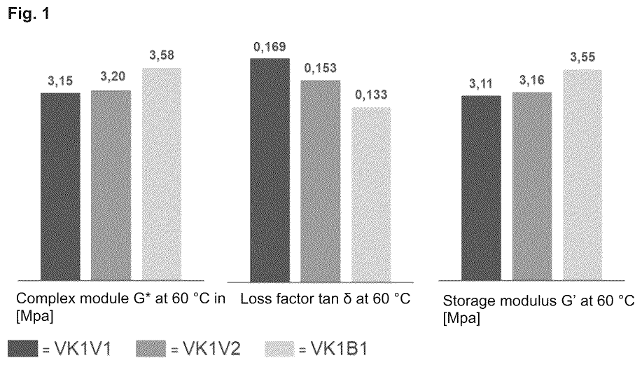

The results shown in Table 3.5 regarding the loss factor tan delta are graphically illustrated in FIG. 1. FIG. 1 shows the reduction of the loss factor by the partial replacement of the industrial carbon black with the organic filler L1 and the addition of the sulfur-functional organosilane.

Table 3.6 summarizes the results obtained for the comparative examples VK2V1 and VK2V2 as well as for the rubber compositions VK2B1, VK2B2, VK2B3, VK2B4 and VK2B5 vulcanized according to the invention.

TABLE 3.6

| Parameters | VK2V1 | VK2V2 | VK2B1 | VK2B2 | VK2B3 | VK2B4 | VK2B5 |
|---|---|---|---|---|---|---|---|
| Storage | 2.1 | 2.43 | 2.85 | 3.18 | 2.94 | 4.73 | 4.89 |
| modulus G′ | | | | | | | |
| at 60° C. [MPa] | | | | | | | |
| Complex | 2.14 | 2.47 | 2.88 | 3.22 | 2.97 | 4.78 | 4.93 |
| modulus G* | | | | | | | |
| at 60° C. [MPa] | | | | | | | |
| Loss factor | 0.18 | 0.17 | 0.14 | 0.14 | 0.14 | 0.14 | 0.12 |
| tan delta | | | | | | | |
| at 60° C. | | | | | | | |

The dynamic stiffness of the vulcanized rubber compositions according to the invention VK2B1, VK2B2, VK2B3, VK2B4 and VK2B5, described by the complex modulus, is surprisingly higher than in the case of the comparative examples VK2V1 and VK2V2 with industrial carbon black as the sole filler. At the same time, the rubber compositions VK2B1, VK2B2, VK2B3, VK2B4 and VK2B5 vulcanized according to the invention surprisingly show significantly lower loss factors tan delta than in the case of the comparative examples VK2V1 and VK2V2 with industrial carbon black as the sole filler. The rubber compositions with lignin L3 as the sole filler, VK2B4 and VK2B5, as compared to the rubber composition VK2B3 with lignin L2 as the sole filler, show a particularly pronounced improvement of these parameters over the rubber compositions VK2V1 and VK2V2 with carbon black as the sole filler. The high dynamic stiffness in combination with the low loss factor as an indicator for the hysteresis, the conversion of mechanical energy into heat, is unique to these lignin-based fillers. This reduction of heat formation reduces the rolling resistance of the tire, with positive effects to fuel consumption and CO₂ emissions of the vehicle. By better decoupling these two rubber-technical key values, as compared to rubber compositions that contain industrial carbon black, the lignin-based compositions disclosed herein are very well suited for employment in rubber articles that are used under dynamic deformation, e.g., for the use in compounds for tire carcasses, in order to improve the rolling resistance of tires, or in technical rubber articles.

1. A vulcanizable rubber composition, comprising a rubber component K, a filler component F and a vulcanization system VS, wherein
the vulcanization system VS comprises at least sulfur and/or at least one sulfur donor,
the rubber component K contains at least one rubber that is cross-linkable by means of sulfur,
the filler component F contains at least one organic filler that has a ¹⁴C content in a range from 0.20 to 0.45 Bq/g of carbon and a BET surface area in a range from >20 to 150 m²/g, and
the vulcanizable rubber composition further comprises at least one organosilane as a part of the filler component F, wherein the at least one organosilane has at least one hydrolysable group and at least one sulfur atom, and is present in the rubber composition in a quantity in a range of from 0.25 to 5 phr.

2. The rubber composition according to claim 1, wherein the at least one rubber of the rubber component K that is cross-linkable by means of sulfur is a diene rubber selected from the group consisting of natural rubber (NR), synthetic natural rubber, and mixtures thereof.

3. The rubber composition according to claim 1, characterized in that the organic filler has a statistical thickness surface area (STSA) in a range from >18 to <150 m²/g, and/or a BET surface area in a range from 25 to 120 m²/g, and/or a d99 of <25 μm, wherein the d99 preferably is determined by means of laser diffraction according to ISO 13320:2009.

4. The rubber composition according to claim 1 wherein the organic filler has an oxygen content in a range from >8% by weight to <30% by weight, and/or a carbon content in a range from >60% by weight to <90% by weight, relative to the ash-free and water-free filler, respectively.

5. The rubber composition according to claim 1, wherein the at least one organic filler is present in the rubber composition in a quantity in a range of from 1 to 150 phr.

6. The rubber composition according to claim 1, wherein the organic filler is a lignin-based filler.

7. The rubber composition according to claim 1, wherein the at least one organosilane is a compound of the general formula (I) and/or (II)
Si(X)_{4-y}(R)_{y} (i),
(X)_{3-z}(T)_{z}Si-(RA)-Si(X)_{3-z}(T)_{z} (II)
wherein, in the case of the general formula (I),
X respectively and independently from one another represents a hydrolysable group that is reactive with phenolic OH groups, phenolate groups, aliphatic OH groups, carboxylic acid groups, carboxylate groups and/or mixtures of these groups, the hydrolysable group respectively and independently from one another representing an alkoxy group,
the parameter y represents an integer in the range of 1 to 3, and
R represents a non-hydrolysable organic radical, optionally an aliphatic C₃ to C₂₀ radical having at least one sulfur atom, wherein the sulfur atom is part of at least one functional group that is selected from the group consisting of thiol groups, blocked thiol groups, di- and/or polysulfide groups, and mixtures thereof,
wherein, in the case of the general formula (II),
X respectively and independently from one another represents a hydrolysable group that is reactive with phenolic OH groups, phenolate groups, aliphatic OH groups, carboxylic acid groups, carboxylate groups and/or mixtures of these groups, the hydrolysable group independently from one another representing an alkoxy group,
RA represents a non-hydrolysable organic radical with two bonds, preferably optionally an aliphatic C₆ to C₂₀ radical with two bonds that contains at least one sulfur atom,
the parameter z respectively represents an integer in the range of 0 to 2, and
T represents a non-hydrolysable organic radical that is different from the radical RA and has no functional groups, and optionally is an aliphatic C₁ to C₂₀ radical.

8. The rubber composition according to claim 7, wherein the at least one organosilane is
a monosilane of the general formula (I) with at least one mercaptoalkyl group R, wherein R optionally is an aliphatic C₃ to C₈ radical, and with at least one group X, optionally contains two or three groups X, is selected from the group consisting of 4-mercaptobutyltrialkoxysilane and/or 6-mercaptohexyltrialkoxysilane and/or 3-mercaptopropyltrialkoxysilane, wherein alkoxy groups preferably mean, independently from one another, methoxy or ethoxy groups, and/or
a bis(silane) of the general formula (II) wherein the non-hydrolysable organic radical RA optionally is an aliphatic C₆ to C₂₀ radical, and has at least one sulfur atom, optionally a di- or polysulfide group, and contains at least one group X, optionally two or three groups X.

9. The rubber composition according to claim 1, wherein the organosilane is present in the rubber composition in a quantity that in a range of from 0.25 to 3 phr, and/or is present in a quantity, relative to the organic filler, in a range of from 1 to 10% by weight.

10. The rubber composition according to claim 1, wherein the sulfur cross-linking agent is present in the rubber composition in a quantity in a range of from 0.25 to 10 phr.

11. The rubber composition according to claim 1, comprising at least one accelerator for the cross-linking by means of sulfur, which optionally is part of the vulcanization system VS of the rubber composition, and which optionally is selected from the group consisting of dithiocarbamates, xanthogenates, thiurams such as thiuram monosulfide and/or thiuram disulfide and/or tetrabenzyl thiuram disulfide (TbzTD), thiazoles such as 2-mercaptobenzothiazole and/or dibenzothiazyldisulfide, sulfenamides such as N-cyclohexyl-2-benzothiazyl-sulfenamid and/or 2-morpholinothiobenzothiazole and/or N-tert-butyl-2-benzothiazyl-sulfenamide, guanidines such as N,N′-diphenylguanidine, thioureas, dithiophosphates, dipentamethylene thiuram tetrasulfide, 4,4′-dithiodimorpholine, caprolactam disulfide and mixtures thereof.

12. A kit of parts, comprising, in spatially separated form,
as part (A), a rubber composition at least containing a rubber component K that is cross-linkable by means of sulfur, and at least a filler component F containing: at least one organic filler that has a ¹⁴C content in a range from 0.20 to 0.45 Bq/g of carbon and a BET surface area in a range from >20 to 150 m²/g and at least one organosilane having at least one hydrolysable group and at least one sulfur atom, wherein part (A) does however not comprise sulfur and/or at least one sulfur donor of the vulcanization system VS, and
as part (B), the vulcanization system VS comprising the at least sulfur and/or at least one sulfur donor,
wherein the organosilane is present in the filler component F in part (A) in a quantity in a range of from 0.25 to 5 phr.

13. A vulcanized rubber composition, which is obtainable by vulcanization of the vulcanizable rubber composition according to claim 1.

14. A method comprising: obtaining a vulcanizable rubber composition or a vulcanized rubber composition; and producing tires and/or tire components and/or technical rubber articles from the vulcanizable rubber composition or the vulcanized rubber composition, wherein:
the vulcanizable rubber composition is obtained by one of the following:
the vulcanizable rubber composition of claim 1; or
a kit of parts, comprising, in spatially separated form: as part (A), a rubber composition at least comprising a rubber component K that is cross-linkable by means of sulfur and at least a filler component F containing: at least one organic filler that has a ¹⁴C content in a range from 0.20 to 0.45 Bq/g of carbon and a BET surface area in a range from >20 to 150 m²/g and at least one organosilane having at least one hydrolysable group and at least one sulfur atom, the organosilane being present in the filler component F in part (A) in a quantity in a range of from 0.25 to 5 phr, wherein part (A) does however not comprise sulfur and/or at least one sulfur donor of the vulcanization system VS; and as part (B), the vulcanization system VS comprising the at least sulfur and/or at least one sulfur donor;
or
the vulcanized rubber composition is obtained by one of the following:
vulcanizing a mixture of a vulcanization system VS comprising at least sulfur and/or at least one sulfur donor, a rubber component K that is cross-linkable by means of the at least sulfur and/or at least one sulfur donor of the vulcanization system VS, and a filler component F containing: at least one organic filler that has a ¹⁴C content in a range from 0.20 to 0.45 Bq/g of carbon and a BET surface area in a range from >20 to 150 m²/g and at least one organosilane having at least one hydrolysable group and at least one sulfur atom, the organosilane being present in the rubber composition in a quantity in a range of from 0.25 to 5 phr; or
vulcanizing part (A) and part (B) of a kit of parts, comprising, in spatially separated form: as the part (A), a rubber composition at least comprising a rubber component K that is cross-linkable by means of sulfur and at least a filler component F containing: at least one organic filler that has a ¹⁴C content in a range from 0.20 to 0.45 Bq/g of carbon and a BET surface area in a range from >20 to 150 m²/g and at least one organosilane having at least one hydrolysable group and at least one sulfur atom, the organosilane being present in the filler component F in part (A) in a quantity in a range of from 0.25 to 5 phr, wherein part (A) does however not comprise sulfur and/or at least one sulfur donor of the vulcanization system VS; and as part (B), the vulcanization system VS comprising the at least sulfur and/or at least one sulfur donor.

15. A tire, a tire component, or a technical rubber article, respectively produced by employing the vulcanizable rubber composition according to claim 1, or a kit of parts which comprises, in spatially separated form: as the part (A), a rubber composition at least comprising a rubber component K that is cross-linkable by means of sulfur and at least a filler component F containing: at least one organic filler that has a ¹⁴C content in a range from 0.20 to 0.45 Bq/g of carbon and a BET surface area in a range from >20 to 150 m²/g and at least one organosilane having at least one hydrolysable group and at least one sulfur atom, the organosilane being present in the filler component F in part (A) in a quantity in a range of from 0.25 to 5 phr, wherein part (A) does however not comprise sulfur and/or at least one sulfur donor of the vulcanization system VS; and as part (B), the vulcanization system VS comprising the at least sulfur and/or at least one sulfur donor.

16. The rubber composition according to claim 2, wherein the at least one rubber of the rubber component K that is cross-linkable by means of sulfur is a synthetic natural rubber comprising a diene rubber selected from the group consisting of: isoprene rubber (IR), styrene butadiene rubber (SBR), solution-polymerized styrene butadiene rubber (SSBR), emulsion-polymerized styrene butadiene rubber (ESBR), butadiene rubber (BR), chloroprene rubber (CR), acrylonitrile butadiene rubber (NBR; nitrile rubber), isobutylene isoprene rubber (IIR), brominated isobutylene isoprene rubber (BIIR), chlorinated isobutylene isoprene rubber (CIIR), and mixtures thereof.

17. The rubber composition according to claim 6, wherein at least the lignin and/or the organic filler as such, is present at least partially in a form that can be obtained by means of hydrothermal treatment, which has been optionally carried out at a temperature in a range from >100° C. to <300° C.

18. The rubber composition according to claim 8, wherein the at least one organosilane is a bis(silane) of the general formula (II), selected from the group consisting of bis(dimethylethoxysilylpropyl) tetrasulfide (DMESPT), bis(dimethylethoxysilylpropyl) disulfide (DMESPD), bis(triethoxysilylpropyl) tetrasulfide (TESPT), bis(triethoxysilylpropyl) disulfide (TESPD) and mixtures thereof.

19. The method of claim 14, wherein: the tires comprise pneumatic tires, solid tires; or the tire components comprise base components, optionally selected from components under the tread, shoulder strips (wings), cap-plies, belts, beads and/or bead reinforcements; and/or the technical rubber articles are selected from drive belts, straps/belts, molded parts optionally including buffers/cushions, bearings/mounts.

20. A tire, a tire component, or a technical rubber article, respectively produced by employing a vulcanized rubber composition according to either claim 13 or a vulcanized part (A) and part (B) of a kit of parts, which comprises, in spatially separated form: as the part (A), a rubber composition at least comprising a rubber component K that is cross-linkable by means of sulfur and at least a filler component F containing: at least one organic filler that has a ¹⁴C content in a range from 0.20 to 0.45 Bq/g of carbon and a BET surface area in a range from >20 to 150 m²/g and at least one organosilane having at least one hydrolysable group and at least one sulfur atom, the organosilane being present in the filler component F in part (A) in a quantity in a range of from 0.25 to 5 phr, wherein part (A) does however not comprise sulfur and/or at least one sulfur donor of the vulcanization system VS; and as part (B), the vulcanization system VS comprising the at least sulfur and/or at least one sulfur donor.
